(19) United States
(12) Patent Application Publication
(10) Pub. No.: US 2023/0237168 A1
(43) Pub. Date: Jul. 27, 2023

(54) CXL-CACHE/MEM PROTOCOL INTERFACE (CPI) LATENCY REDUCTION MECHANISM

(71) Applicants: Swadesh Choudhary, Mountain View, CA (US); Robert Blankenship, Tacoma, WA (US); Mohannad Fahim Ali, San Jose, CA (US); Raghunandan Makaram, Northborough, MA (US)

(72) Inventors: Swadesh Choudhary, Mountain View, CA (US); Robert Blankenship, Tacoma, WA (US); Mohannad Fahim Ali, San Jose, CA (US); Raghunandan Makaram, Northborough, MA (US)

(21) Appl. No.: 18/193,231

(22) Filed: Mar. 30, 2023

Related U.S. Application Data
(60) Provisional application No. 63/433,376, filed on Dec. 16, 2022.

(51) Int. Cl. G06F 21/60; G06F 21/85

(52) U.S. Cl. CPC G06F 21/602; G06F 21/85

(57) ABSTRACT

Embodiments herein relate to an electronic device with an interface an interface to communicatively couple with a second electronic device via a communication link, and a link controller. The link controller may be configured to identify, from the second electronic device over the communication link, a flit related to a request from the second electronic device to access a resource of the first electronic device, wherein the flit is an element of a message authentication code (MAC) epoch; generate, based on the flit, a cache/mem interface message related to the request, wherein the cache/mem interface message includes an indication of the MAC epoch; and transmit, to a device fabric of the first electronic device, the cache/mem interface message prior to receipt of a MAC related to the MAC epoch. Other embodiments may be described and/or claimed.

### CROSS-REFERENCE TO RELATED APPLICATIONS

The present application claims priority to U.S. Provisional Patent Application 63/433,376, filed on Dec. 16, 2022, the contents of which are incorporated herein in their entirety.

### BACKGROUND

Embodiments of the present disclosure generally relate to the field of compute express link (CXL)-cache/mem protocol interface (CPI) latency.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example system topology, in accordance with various embodiments.

FIGS. 2A and 2B (collectively, “FIG. 2”) illustrates an example CXL.Mem master to subordinate (M2S) Read Request with Containment, in accordance with various embodiments.

FIGS. 3A and 3B (collectively, “FIG. 3”) illustrates an example CXL.Mem M2S Read Request with Optimization, in accordance with various embodiments.

FIG. 4 illustrates an example process related to latency reduction, in accordance with various embodiments.

FIG. 5 illustrates an example computing system suitable for practicing various aspects of the disclosure, in accordance with various embodiments.

FIG. 6 illustrates an example non-transitory computer-readable storage medium having instructions configured to practice all or selected ones of the operations associated with the processes described in reference to FIG. 1-4, 7, or 8, and/or some other method, process, or technique described herein, in whole or in part.

FIG. 7 relates to a process to be performed by a link controller of an electronic device, in accordance with various embodiments.

FIG. 8 relates to a process to be performed by a device fabric of an electronic device, in accordance with various embodiments.

### DETAILED DESCRIPTION

Embodiments described herein may include apparatus, systems, techniques, or processes that are directed to CPI latency. Specifically, embodiments relate to CPI latency reduction mechanisms for a CXL.CacheMem integrity and data encryption (IDE) containment mode.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

Additionally, it will be understood that although embodiments herein are described with respect to fabric interfaces, CXL and/or CPI, such description is done for the sake of discussion of concepts of the general disclosure. Specifically, CXL is used herein as an example of a communication link. CPI is used herein as an example of a cache/mem interface. In other embodiments, a different communication link and/or a different cache/mem interface may be used. One example of a different interface may include a streaming fabric interface (SFI) using interface-specific mechanics. As a result, critical memory latencies may be reduced in various different interfaces without compromising the Containment IDE security mode benefits.

CXL.cachemem IDE Containment Mode, as defined by the CXL Specification (e.g., the Compute Express Link Specification Revision 3.0, Version 1.0, published by the Compute Express Link Consortium, Inc., published Aug. 1, 2022) may direct that data transferred over a CXL link may only be released after a message authentication code (MAC) is received and checked for integrity. Because a MAC may be generated based on a variable number of flits (which may be referred to herein as a “MAC epoch”), this requirement for an integrity check may inherently add latencies for requests. Specifically, a transmitter may be required to send the flits of the MAC epoch, generate the MAC, and then insert the MAC into an appropriate slot for subsequent transmission (e.g., on a subsequent epoch). This latency may be compounded with loaded links, link bifurcation, and data flits that may all contribute to a delayed MAC transmission.

As used herein, the term “flit” may generally refer to a unit amount of data when a message is being transmitted over a link. More specifically, the term flit as used herein, may be, or may be similar to, the term “flit” as described or defined by the Compute Express Link Specification as referenced above, or some other future version of such specification.

Similarly, the term “fabric” or “device fabric” may refer to one or more switches, ports, and or logical elements that connect different nodes of an electronic device. More specifically, a fabric may be, or may be similar to, the term “fabric” as used, described, or defined by the Computer Express Link Specification as referenced above, or some other future version of such specification.

In embodiments herein, device memory latency may be reduced by extending the containment boundary into the device fabric using CPI. As used herein, the term “containment boundary” may refer to containment of the data or packets transferred over the CXL link. The packets may not be released (e.g., transferred to another processing element such as another piece of hardware, software, or firmware for processing) until the MAC integrity check is complete. Rather, they may be stored (e.g., placed in a buffer or cache such as a CXL cache) until such time as the MAC integrity check is complete, at which point they may be transferred (e.g., to a host fabric or device fabric).

With this change, the device fabric may begin processing a memory request in terms of prefetching etc. from CXL as soon as the request is available, rather than experiencing increased latency or decreased performance due to having to wait for occurrence of an integrity check. The MAC may be generated and transmitted in parallel with this processing, and then an integrity check may be performed at a later point in time and before the request is committed to memory or data becomes visible. In addition, the ideas presented here may also reduce or resolve MAC-related latency in scenarios with link subdivided ports below a common Fabric Interface of CPI.

Generally, in embodiments herein, CPI message packet formats may be modified to provide additional information such as source epoch information to the device fabric. The source epoch information may include, for example, an epoch identifier (ID) and/or originating port information for the bifurcated case. However, it will be noted that this information is intended as one example of such information, and other embodiments may include additional or alternative information as part of or related to the source epoch information.

This additional source epoch information may enable the fabric to begin processing requests while tracking the originating epoch that sourced the request. CPI Global Layer wires may be added to the system so that the fabric can be notified of the status of the integrity check when it has been completed. In other embodiments, such wires may have an additional or alternative name, or the status notification to the fabric may be performed in some different way (e.g., using a different signaling pathway on existing wires, etc.). The fabric may then complete or terminate the associated requests with the originating epoch as necessary based on the received integrity check status notification.

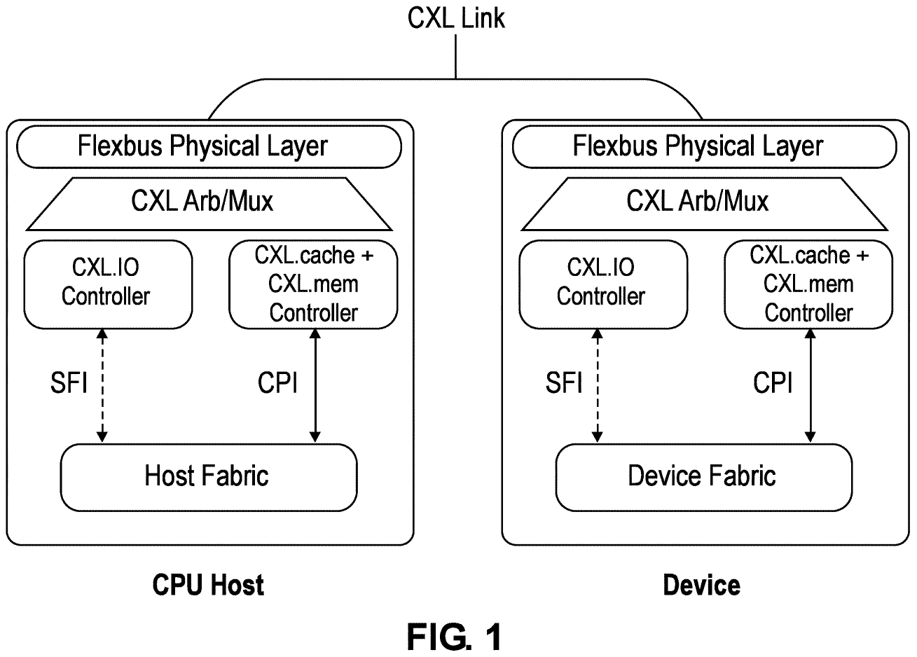

FIG. 1 shows an example system topology that utilizes CPI interfaces to connect CXL cachemem controllers (depicted in FIG. 1 as “CXL.cache+CXL.mem Controller”) to Host and Device fabrics of a central process unit (CPU) host and device, respectively. When a CXL link is operating in IDE Containment Mode, receivers (e.g., either the CPU host receiving data from the device, or vice-versa) may be required to hold on to any received protocol packets until the corresponding MAC arrives and is verified for integrity before releasing for further processing. For latency-sensitive flows such as memory reads, this hold may consume valuable time that could be used to pre-process the request.

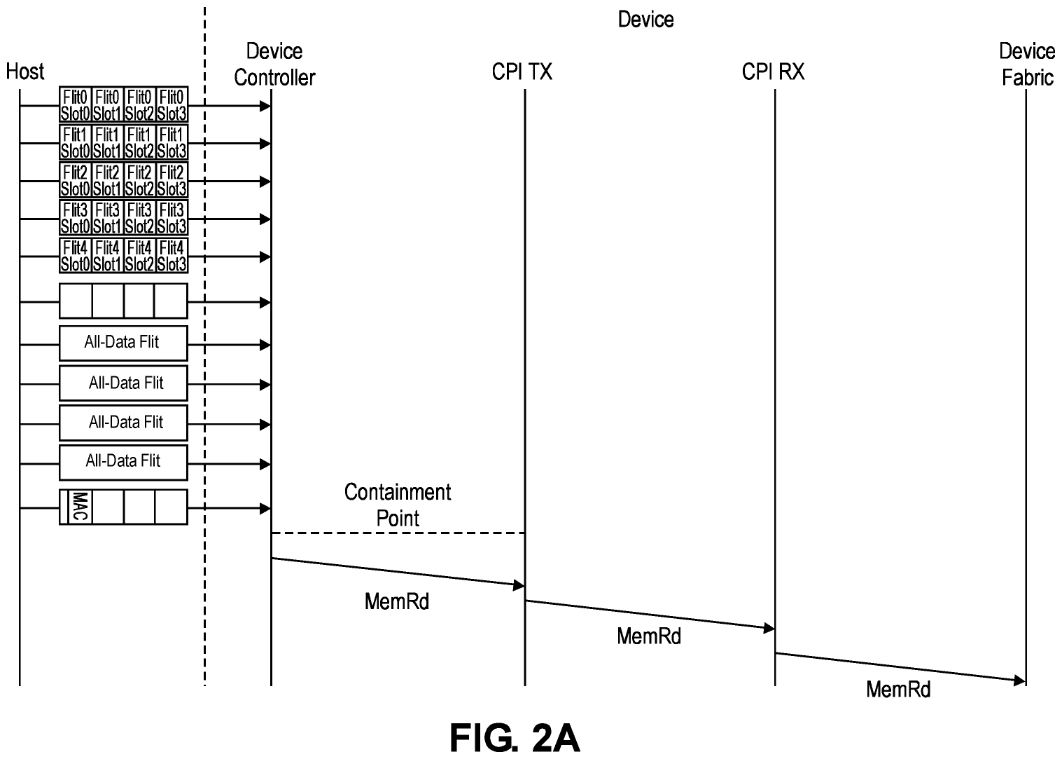

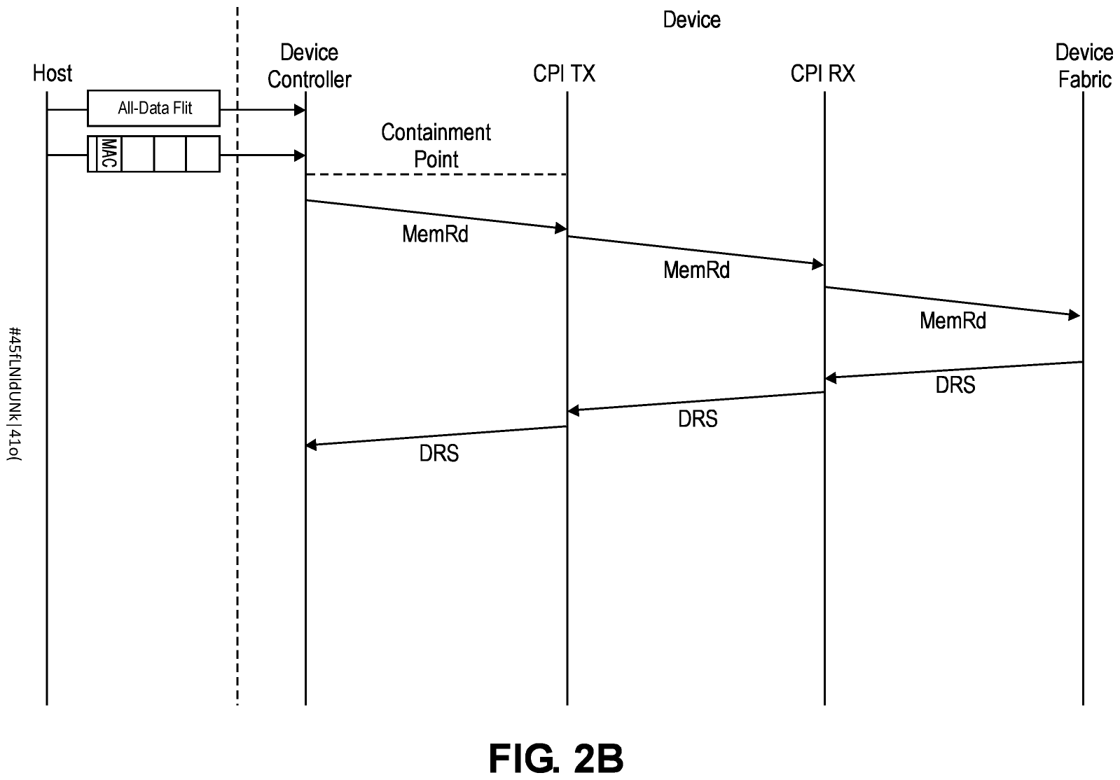

FIGS. 2A and 2B (collectively, “FIG. 2,” wherein a slight overlap is shown between FIGS. 2A and 2B to assist a reader with fully identifying the associated process flow) demonstrate an example Host to Device memory read that is held up in the device controller (e.g., the device cachemem controller) until the MAC epoch completes, and the MAC is transmitted and checked for integrity (labelled in FIG. 2 as “Containment Point”). For 0065 ample, the MAC epoch may include one or more of the data units labelled with a Flit and Slot indicator, an All-Data Flit (which may be referred to herein as “ADF”, or some other flit. The MAC may then be transmitted in the data unit labelled as “MAC” in FIG. 2. As may be seen, memory read (labelled as “MemRd”) requests between the device controller, CPI transmitter (TX), CPI receiver (CPI RX), and device fabric, along with corresponding data responses (labelled as “DRS” in FIG. 2B) may not be transmitted until the Device Controller receives the MAC.

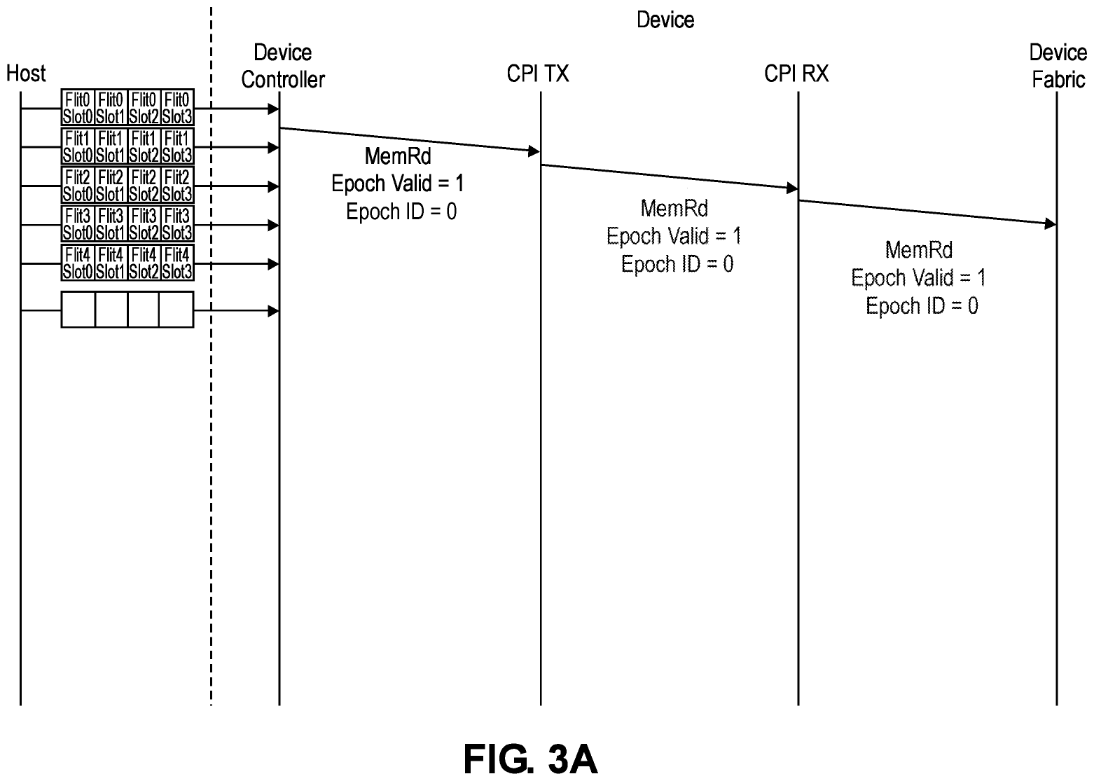

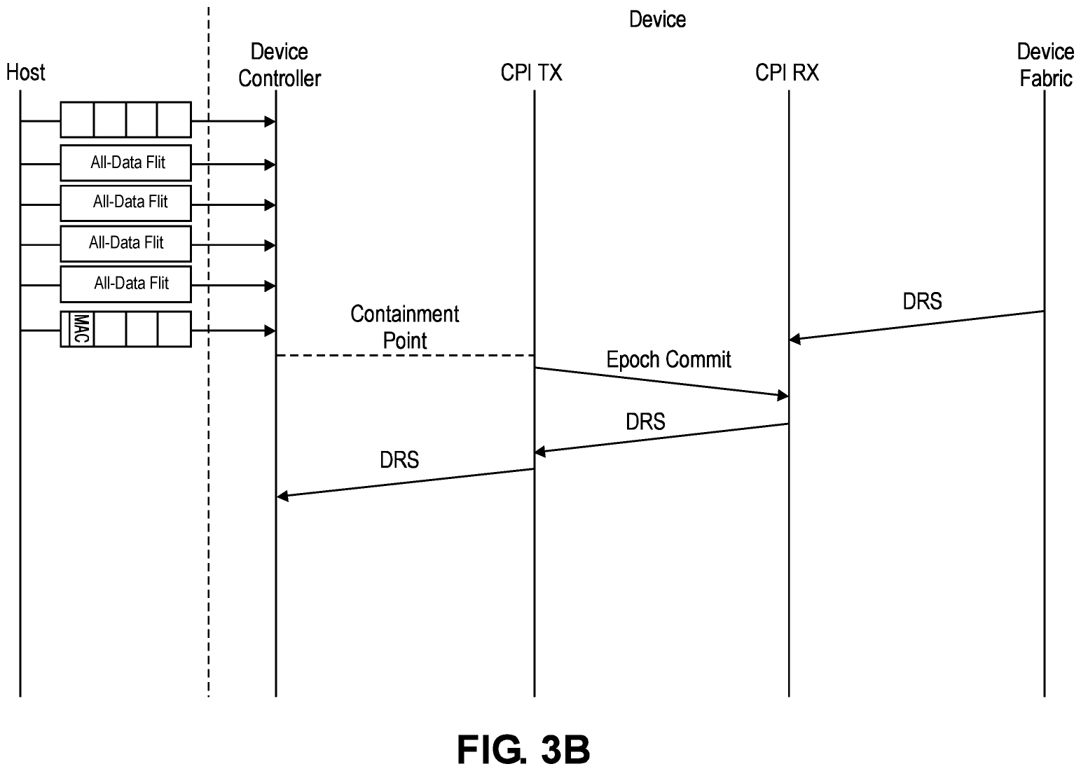

As previously noted, FIG. 2 is divided between FIGS. 2A and 2B for the sake of readability of the Figure. As may be seen, there is some overlap between the bottom of FIG. 2A and the top of FIG. 2B, which is intended to assist the reader in following the depicted process flow between the two sub-Figures. For the sake of the Figures, the Device Controller, CPI TX, CPI RX, and Device Fabric may be contained in the Device (e.g., the Device of FIG. 1), as illustrated. It will further be understood that FIG. 3 is structured similarly to FIG. 2 in that FIG. 3 is a single Figure that is split between FIGS. 3A and 3B for the sake of readability, and includes some degree of overlap for the sake of assisting a reader in following the depicted process flow. The Device and its components, as well as the Host, are similarly illustrated.

Table 1 and Table 2 provide an approximate example calculation of pessimistic latencies incurred due to MAC authentication for 68 byte (B) and 256 B Flit Modes respectively, represented in flits. As used in, the term “pessimistic” may refer to an assumption of worst-case latency scenarios. Additionally, a 68 B Flit Mode and 256 B Flit Mode, as used herein, may be, or may be similar to, those modes as described by the Compute Express Link Specification as referenced above, or some other future version of such specification.

Based on the above, the values of Tables 1 and 2 may represent the number of flit transfers across the CXL link that may be required to occur to complete a MAC authentication process. It will be noted that Tables 6 and 7, described below, may provide additional information regarding how much time each flit transfer may take. As such, the total amount of time required to complete a MAC authentication process may be based on Tables 1 or 2, combined with Tables 6 or 7, respectively, to achieve such total amounts of time.

In Tables 1 and 2, the latencies are described with respect to three scenarios:
Idle: Truncated MAC epoch;
Loaded: Fully packed MAC epoch with critical request sent on first flit;
Loaded+ADF: Fully packed MAC epoch with critical request sent on first flit and MAC transmission delayed due to presence of ADFs.

TABLE 1
Example breakdown of pessimistic round-trip latencies
for Host-to-Device Memory Read for 68B Flit Mode

| | | | | Subordinate to Master | | |
|---|---|---|---|---|---|---|
| | M2S Path Latency (flits) | | | (S2M) Path latency (flits) | | |
| | | | Loaded + | | | Loaded + |
| | Idle | Loaded | ADF | Idle | Loaded | ADF |
| Critical Flit | 1 | 1 | 1 | 2 | 2 | 2 |
| Transfer | | | | | | |
| Transfer | 0 | 4 | 4 | 0 | 3 | 3 |
| Remaining | | | | | | |
| Flits in | | | | | | |
| Epoch | | | | | | |
| Calculate | 1 | 1 | 1 | 1 | 1 | 1 |
| MAC | | | | | | |
| Transmit | 1 | 1 | 6 | 1 | 1 | 6 |
| MAC | | | | | | |
| Verify | 1 | 1 | 1 | 1 | 1 | 1 |
| MAC | | | | | | |
| Total | 4 | 8 | 13 | 5 | 8 | 13 |

TABLE 2
Example breakdown of pessimistic round-trip latencies
for Host-to-Device Memory Read for 256B Flit Mode

| | M2S Path Latency (flits) | | | S2M Path latency (flits) | | |
|---|---|---|---|---|---|---|
| | | | Loaded + | | | Loaded + |
| | Idle | Loaded | ADF | Idle | Loaded | ADF |
| Critical Flit | 1 | 1 | 1 | 1 | 1 | 1 |
| Transfer | | | | | | |
| Transfer | 0 | 1 | 1 | 0 | 1 | 1 |
| Remaining | | | | | | |
| Flits in | | | | | | |
| Epoch | | | | | | |
| Calculate | 1 | 1 | 1 | 1 | 1 | 1 |
| MAC | | | | | | |
| Transmit | 1 | 1 | 2 | 1 | 1 | 2 |
| MAC | | | | | | |
| Verify | 1 | 1 | 1 | 1 | 1 | 1 |
| MAC | | | | | | |
| Total | 4 | 5 | 6 | 4 | 5 | 6 |

Embodiments here may provide a mechanism for the controller and fabric to communicate epoch integrity information over CPI to allow for pre-processing of protocol packets ahead of the containment point to reduce latencies.

In embodiments, CPI packet formats (e.g., packets related to the CPI Request Layer, the CPI DATA Layer, the CPI Response Layer, etc.) may be augmented to include one or more of the following fields for CXL.Mem packet formats:

1. Epoch Valid: Single-bit indication that the associated Epoch identifier (ID)/Port ID fields are valid

2. Epoch ID: Single-bit identifier to associate a protocol request with the epoch that sourced it

3. Port ID: Variable-width field to indicate port ID that sourced the request

A single bit of an Epoch ID (e.g., as described with respect to element (1) and/or element (2), above) may be sufficient for the optimized use case due to the pipelined and ordered nature of epochs and their associated MAC transmission. In an example optimized use case, the MAC for a given epoch may be delivered through the subsequent epoch (e.g., transmitted in a sequence related to flits of a subsequent MAC epoch), thereby freeing up the ID of the first epoch, and so on. In an example non-optimized use case where more than two MAC epochs may be in flight (e.g., being transmitted) at least partially at the same time, the controller may not be allowed to expose any packets from the additional MAC epoch over CPI. Rather, the controller may be required to instead wait for containment before exposing any packets from that MAC epoch. In some embodiments, the receiving fabric may be required to concatenate the Port ID and Epoch ID to form a unique identifier for tracking.

Generally, the above-described fields may carry sufficient information for the CPI Receiver to begin pre-processing the request while waiting for MAC authentication. For example, the CPI receiver may prefetch data that is being requested. In some embodiments, the Receiver may be required to ensure that any requested data is not visible, and no updates are committed (e.g., no change to the system is performed based on receipt of the request), until MAC authentication is complete. In some embodiments, the fabric of the Receiver (e.g., the device fabric or the host fabric) may choose to achieve this by using the CXL.mem defined MemSpecRd flow to start the memory access without directly exposing the standard Read flow to all areas of the on-die fabric.

Three new signals added to the CPI Global Layer Agent to Fabric (A2F) wires may allow a controller to provide the MAC integrity check status to the fabric. It will be understood that these signals are intended as examples of such signals and other embodiments may use more, fewer, or different signals. In some embodiments, the name of the signal (e.g., the entry in the “Signal Name” column) may be different, while still performing the listed function.

TABLE 3
CPI Global Layer wire additions to deliver authentication status

| Signal | Signal | | | |
|---|---|---|---|---|
| Group | Name | Direction | Width | Description |
| IDE | Epoch_id | Agent −> | P bits | Optional signal: |
| | | Fabric | | Per-port MAC |
| | | | | Epoch ID used to |
| | | | | indicate MAC |
| | | | | authentication |
| | | | | status. |
| | Eopch_commit | Agent −> | P bits | Optional signal: |
| | | Fabric | | Per-port MAC |
| | | | | Epoch successful |
| | | | | authentication |
| | | | | status. |
| | Epoch_reject | Agent −> | P bits | Optional signal: |
| | | Fabric | | Per-port MAC |
| | | | | Epoch unsuccessful |
| | | | | authentication |
| | | | | status. |

The width of the above-listed three signals (or other signals as may be used in various embodiments) may be dependent on the number of instantiated ports, with respective ports mapping to one of the indices with consistent mapping for all three fields. For example, for P=4 ports present, epoch_id[0]/epoch_commit[0]/epoch_reject[0] may carry status information related to port0; epoch_id[1]/epoch_commit[1]/epoch_reject[1] may carry status information related to port1, etc. For each present port, once the MAC for an epoch has been received and checked for integrity, the status of the check can be communicated to the fabric of the receiving device by asserting either the epoch_commit for a successful check or the epoch_reject for an unsuccessful check along with the corresponding epoch_id for the correct port-based bit position.

The CPI receiver may then concatenate the port ID (e.g., by detecting which bit is being asserted) and the epoch_id to update the authentication status and complete processing for any previously received requests. The CPI receiver may be required to wait for the MAC authentication status before releasing any data when in Containment Mode.

Receiver behavior for the unsuccessful MAC authentication case may be implementation specific (e.g., how the failure of the MAC authentication is handled), but the receiver may not be allowed to expose or update any system state based on one or more flits related to the MAC epoch for which the MAC authentication failed. If this mode is disabled for any port, the CPI TX may communicate this disablement by asserting both epoch_commit and epoch_reject concurrently on the relevant port bits.

FIG. 3 demonstrates an example Host to Device memory read that is in accordance with embodiments herein. Specifically, FIG. 3 depicts an example process flow that may be used by the device to use one or more of the above-described signals to pre-process the requested memory read in parallel to performance of the MAC authentication check. In this case, the controller of the receiving device (e.g., the Device of FIG. 3) may immediately forward the protocol request (indicated as MemRd in FIG. 3) to the device fabric to begin processing, instead of waiting for the Containment Point as was depicted in FIG. 2. This request to the fabric may be tagged with an Epoch Valid=1 value and an Epoch ID=0 value, as shown in FIG. 3A. While the device is pre-processing the read request, the MAC may arrive at the receiver as shown in FIG. 3B and be verified, at which point the device controller may signal to the device fabric that MAC authentication was successful (e.g., as may be indicated at the “Epoch Commit” element in FIG. 3B). At this point, the fabric or, in this embodiment the CPI RX, may complete the request and release the data as shown in FIG. 3B. It will be noted that, as shown in FIG. 3B, the data may begin to be transmitted from the device fabric along the signal pathway to the device controller prior to, or concurrently with, reception of the MAC. For example, as shown in FIG. 3B, the data (e.g., the DRS) may be transmitted from the device fabric to the CPI RX generally concurrently with reception of the MAC at the Device Controller from the Host. It will be noted that, in some embodiments, if the MAC validation fails, then any pre-fetched data may be disposed of (e.g., not forwarded and/or overwritten).

Similarly, on the S2M data response (DRS) path on the CPI DATA Layer, the same mechanic may be used to begin pre-processing flits received on the Host side. While there may be no need for prefetching in this scenario, any checks or operations that the receiving controller would typically perform after MAC authentication may begin to further reduce latency. This and other embodiments may be structured as implementation choices to take advantage of this mechanic.

Specifically, memory fetch requests may experience a more drastic or obvious savings in latency because the result of such a request is typically a completion of such request (e.g., a response). However, some other packet types may not necessarily have such a response (e.g., a S2M DRS packet). As such, a prefetch functionality may not introduce significant latency savings because there may be no data to prefetch. However, even in these scenarios, some embodiments may still be able to begin processing the request, packetizing relevant data, and scheduling such data for transmissions prior to (or concurrently with) the MAC authentication process. As such, at least some amount of latency savings may still be realized.

Using the Host to Device memory read example described above (e.g., with respect to FIG. 3) and assuming that device memory access latency is larger than the overall MAC authentication delay, M2S MAC latency overhead may be significantly reduced. Additionally, in some embodiments, S2M DRS latencies may also be reduced depending on implementation, for example as described above.

Table 4 and Table 5 provide approximate example calculation of latencies in accordance with embodiments herein wherein a CPI receiver may at least partially prefetch data prior to MAC authentication (e.g., as shown and discussed with reference to FIG. 3). Table 4 may correspond to a 68 B Flit Mode, and Table 5 may correspond to a 256 B Flit Modes. Similarly to Tables 1 and 2, the values of Tables 4 and 5 may be represented in flits. As may be seen in Tables 4 and 5, the M2S latency may be significantly reduced. Additionally, a 0.5 multiplier may be applied to the S2M latency values from Tables 1 and, which may be a reasonable assumption to represent potential savings that a design may choose to implement as discussed above.

TABLE 4
Example optimized round-trip latencies for Host-
to-Device Memory Read for 68B Flit Mode

| | Master to Subordinate | | | Subordinate to Master | | |
|---|---|---|---|---|---|---|
| | (M2S) Path Latency (flits) | | | (S2M) Path latency (flits) | | |
| | | | Loaded + | | | Loaded + |
| | Idle | Loaded | ADF | Idle | Loaded | ADF |
| Critical Flit | 1 | 1 | 1 | 2 | 2 | 2 |
| Transfer | | | | | | |
| Transfer | 0 | 0 | 0 | 0 | 1.5 | 1.5 |
| Remaining | | | | | | |
| Flits in | | | | | | |
| Epoch | | | | | | |
| Calculate | 0 | 0 | 0 | 0.5 | 0.5 | 0.5 |
| MAC | | | | | | |
| Transmit | 0 | 0 | 0 | 0.5 | 0.5 | 3 |
| MAC | | | | | | |
| Verify | 0 | 0 | 0 | 0.5 | 0.5 | 0.5 |
| MAC | | | | | | |
| Total | 1 | 1 | 1 | 3.5 | 5 | 7.5 |

TABLE 5
Example optimized round-trip latencies for Host-
to-Device Memory Read for 256B Flit Mode

| | M2S Path Latency (flits) | | | S2M Path latency (flits) | | |
|---|---|---|---|---|---|---|
| | | | Loaded + | | | Loaded + |
| | Idle | Loaded | ADF | Idle | Loaded | ADF |
| Critical Flit | 1 | 1 | 1 | 1 | 1 | 1 |
| Transfer | | | | | | |
| Transfer | 0 | 0 | 0 | 0 | 0.5 | 0.5 |
| Remaining | | | | | | |
| Flits in | | | | | | |
| Epoch | | | | | | |
| Calculate | 0 | 0 | 0 | 0.5 | 0.5 | 0.5 |
| MAC | | | | | | |
| Transmit | 0 | 0 | 0 | 0.5 | 0.5 | 1 |
| MAC | | | | | | |
| Verify | 0 | 0 | 0 | 0.5 | 0.5 | 0.5 |
| MAC | | | | | | |
| Total | 1 | 1 | 1 | 2.5 | 3 | 3.5 |

Table 6 and Table 7 provide example expected flit durations in nanoseconds (ns) for different bifurcations for 68 B and 256 B Flit Modes, respectively. A 68 B flit may take approximately 1.06 ns for x16 at 32 gigatransfers per second (GT/s) and a 256 B flit may take approximately 2 ns for x16 at 64 GT/s. As used herein, “x16” may refer to a lane configuration for a CXL link that includes 16 different lanes (e.g., data channels). 32 GT/s may be the transfer speed across the link. In this case, it would take approximately 1.06 ns to send a flit across the CXL link when operating in a 68 B Flit Mode. Similarly, in the 256 B Flit Modes using the same x16 lane configuration, the expected transfer speed may be approximately 64 GT/s across the link, and so each flit would take approximately 2 ns to transfer.

The actual latency may scale up at narrower lane widths (e.g., an approximately 2× latency multiplier may be applied when going from a x16 link to a x8 link, or when going from a x8 link to a x4 link. Similarly, an approximately 4× latency multiplier may be applied when going from a x16 link to a x4 link).

TABLE 6
Example flit latencies for different lane widths for 68B flit mode

| | X16 | X8 | X4 |
|---|---|---|---|
| Flit | 1.0625 | 2.13 | 4.25 |
| latency (ns) | | | |

TABLE 7
Example flit latencies for different lane widths for 256B flit mode

| | X16 | X8 | X4 |
|---|---|---|---|
| Flit | 2 | 4 | 8 |
| latency (ns) | | | |

Tables 8 and 9 combine the data depicted in Tables 4-7 to highlight example latency savings that may be achieved through use of embodiments herein for 68 B and 256 B Flit Modes respectively for different link bifurcation scenarios. As used herein, the term “link bifurcation scenarios” may refer to the different lane widths (e.g., x16, x8, x4, etc.). For each of these scenarios, it may be desirable to identify a “Base” latency, which may relate to the legacy latency values without implementation of embodiments herein. Conversely, the “Optimized” latency may relate to latency values with implementation of the prefetch functionality described herein.

TABLE 8
Example round-trip latency savings for
host-to-device memory read for 68B

| Round-trip | | | | | | |
|---|---|---|---|---|---|---|
| Latency | X16 | | X8 | | X4 | |
| Adder (ns) | Base | Optimized | Base | Optimized | Base | Optimized |
| Idle | 9.5625 | 3.71875 | 19.17 | 7.455 | 38.25 | 14.875 |
| Loaded | 17 | 5.3125 | 34.08 | 10.65 | 68 | 21.25 |
| Loaded + | 27.625 | 7.96875 | 55.38 | 15.975 | 110.5 | 31.875 |
| ADF | | | | | | |

TABLE 9
Example round-trip latency savings for
host-to-device memory read for 256B

| Round-trip | | | | | | |
|---|---|---|---|---|---|---|
| Latency | X16 | | X8 | | X4 | |
| Adder (ns) | Base | Optimized | Base | Optimized | Base | Optimized |
| Idle | 16 | 6 | 32 | 12 | 64 | 24 |
| Loaded | 20 | 7 | 40 | 14 | 80 | 28 |
| Loaded + | 24 | 8 | 48 | 16 | 96 | 32 |
| ADF | | | | | | |

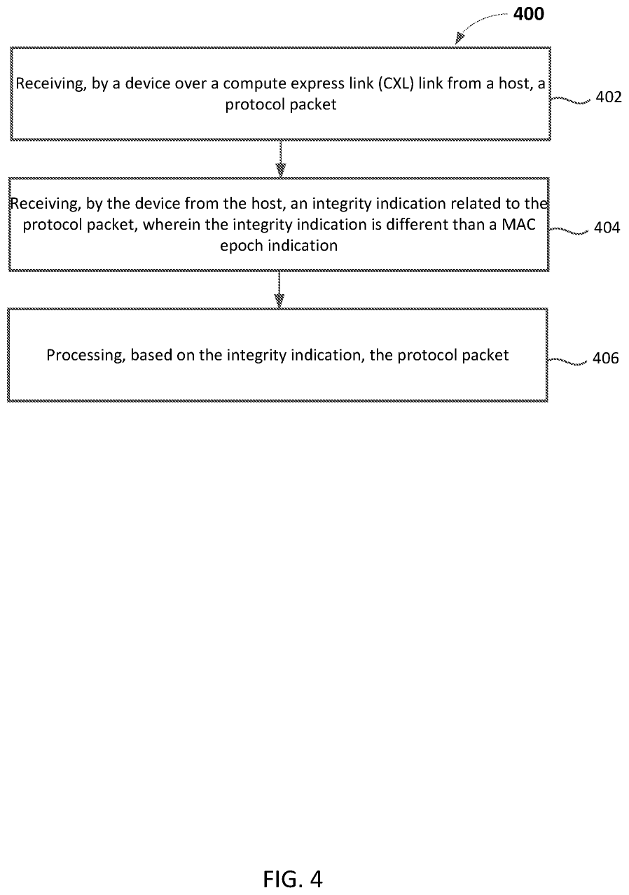

FIG. 4 illustrates an example process 400 related to latency reduction. The process 400 may be performed, for example, by the system 500 (e.g., computing device). More specifically, the process 400 may be performed by one or more processors, modules, ASICs, modules, processor cores, etc., and/or some other hardware/firmware/software, or some combination thereof. In some embodiments, the process 400 may be performed, in whole or in part, by one or more physical layer elements that are part of related to a CXL host and/or a CXL device. For the sake of description of this process, the term “one or more processors” will be used without loss of the above-described generality.

The process 400 may include receiving, at 402 by a device over a compute express link (CXL) link from a host, a protocol packet; receiving, at 404 by the device from the host, an integrity indication related to the protocol packet, wherein the integrity indication is different than a medium access control (MAC) epoch indication; and processing, at 406 based on the integrity indication, the protocol packet.

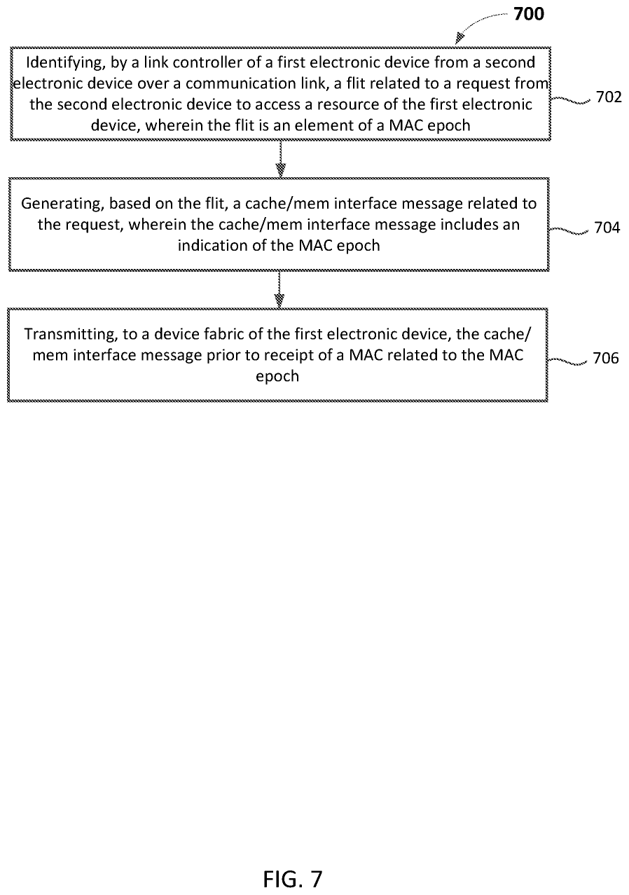

FIG. 7 relates to a process 700 to be performed by a link controller (e.g., a CXL controller) of an electronic device, in accordance with various embodiments. For the sake of description of FIG. 7 herein, the electronic device may be referred to as a “first electronic device.” The process may include or relate to identifying, at 702 from a second electronic device over a communication link (e.g., a CXL link), a flit related to a request from the second electronic device to access a resource of the first electronic device, wherein the flit is an element of a MAC epoch; generating, at 704 based on the flit, a cache/mem interface (e.g., a CPI) message related to the request, wherein the cache/mem interface message includes an indication of the MAC epoch; and transmitting, at 706 to a device fabric of the first electronic device, the cache/mem interface message prior to receipt of a MAC related to the MAC epoch.

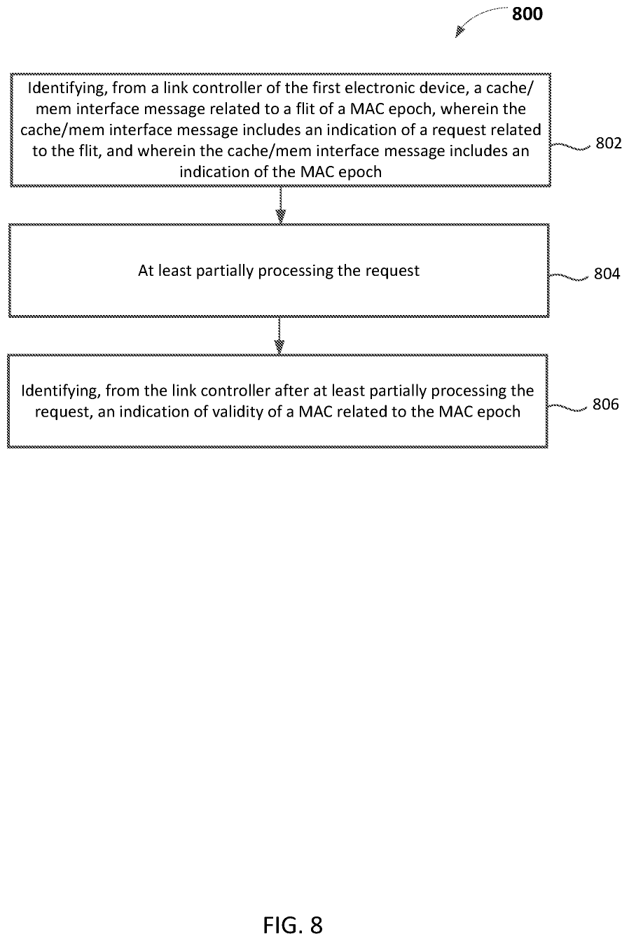

FIG. 8 relates to a process 800 to be performed by a device fabric of an electronic device, in accordance with various embodiments. For the sake of description of FIG. 8 herein, the electronic device may be referred to as a “first electronic device.” The process 800 may include or relate to identifying, at 802 from a link controller (e.g., a CXL controller) of the first electronic device, a cache/mem interface (e.g., a CPI) message related to a flit of a MAC epoch, wherein the cache/mem interface message includes an indication of a request related to the flit, and wherein the cache/mem interface message includes an indication of the MAC epoch; at least partially processing, at 804, the request; and identifying, at 806 from the link controller after at least partially processing the request, an indication of validity of a MAC related to the MAC epoch.

It should be understood that the actions described in reference to FIGS. 4, 7, and/or 8 may not necessarily occur in the described sequence. For example, certain elements may occur in an order different than that described, concurrently with one another, etc. In some embodiments, the processes 400, 700, and/or 800 may include more, fewer, and/or different elements than depicted or described.

It will also be understood that the actions described in reference to FIGS. 4, 7, and/or 8, or some other method, process, or technique described herein, may be performed in whole or in part, by one or more pieces of logic that are implemented as hardware, software, firmware, and/or some combination thereof.

For example, in some embodiments, at least part of the method/process/technique/etc. may be performed by one or more processors, processor cores, or some other element of logic. The element of logic may perform such actions based on instructions received from a media such as a read only memory (ROM), a non-volatile memory (NVM) such as a flash memory, or some other type of memory. The logic and/or memory may be part of, or coupled with, an element such as a link controller or device fabric.

In some embodiments, at least part of the method/process/technique/etc. may be performed by an element of logic such as a module or ASIC that is, that implements, or that is part of a link controller or a device fabric. In some embodiments, the logic may be hardware, firmware, software, and/or some combination thereof. The instructions to perform the elements of the method/process/technique/etc. may be “hard coded” into the ASIC or module (e.g., as firmware) or provided by some form of memory coupled with the ASIC or module (e.g., as software).

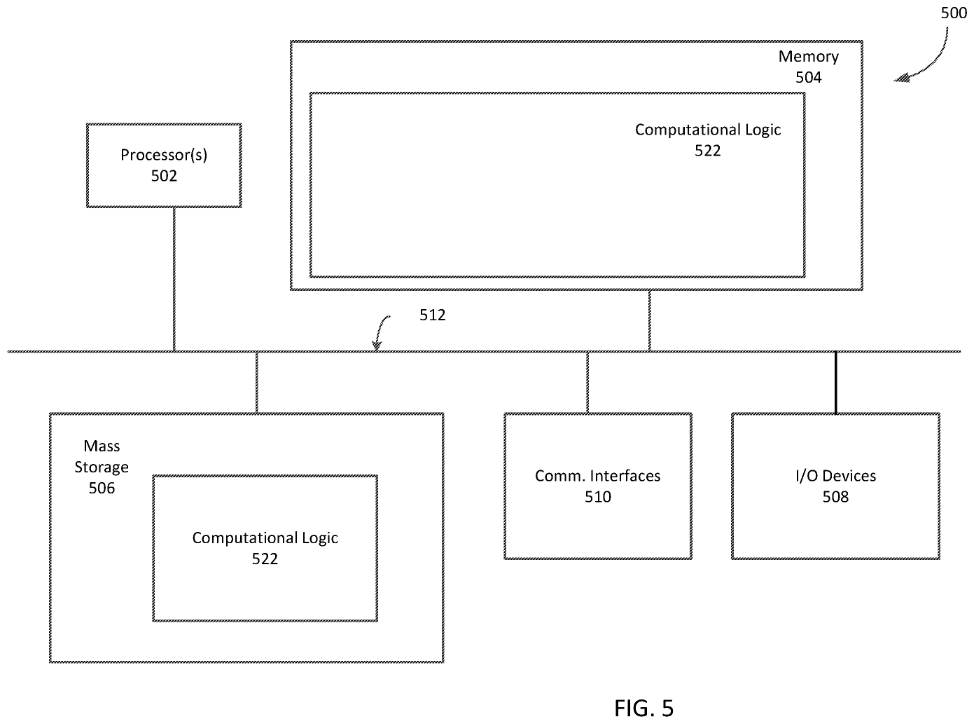

FIG. 5 illustrates an example computing device 500 suitable for use to practice aspects of the present disclosure, in accordance with various embodiments. For example, the example computing device 500 may be suitable to implement the functionalities associated with FIG. 1-4, 7, or 8, and/or some other method, process, or technique described herein, in whole or in part.

As shown, computing device 500 may include one or more processors 502, each having one or more processor cores, and system memory 504. The processor 502 may include any type of unicore or multi-core processors. Each processor core may include a central processing unit (CPU), and one or more level of caches. The processor 502 may be implemented as an integrated circuit. The computing device 500 may include mass storage devices 506 (such as diskette, hard drive, volatile memory (e.g., dynamic random access memory (DRAM)), compact disc read only memory (CD-ROM), digital versatile disk (DVD) and so forth). In general, system memory 504 and/or mass storage devices 506 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 500 may further include input/output (I/O) devices 508 such as a display, keyboard, cursor control, remote control, gaming controller, image capture device, one or more three-dimensional cameras used to capture images, and so forth, and communication interfaces 510 (such as network interface cards, modems, infrared receivers, radio receivers (e.g., Bluetooth), and so forth). I/O devices 508 may be suitable for communicative connections with three-dimensional cameras or user devices. In some embodiments, I/O devices 508 when used as user devices may include a device necessary for implementing the functionalities of receiving an image captured by a camera.

The communication interfaces 510 may include communication chips (not shown) that may be configured to operate the device 500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments.

The above-described computing device 500 elements may be coupled to each other via system bus 512, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions implementing the operations and functionalities associated with FIG. 1-4, 7, or 8, and/or some other method, process, or technique described herein, in whole or in part, generally shown as computational logic 522. Computational logic 522 may be implemented by assembler instructions supported by processor(s) 502 or high-level languages that may be compiled into such instructions.

The permanent copy of the programming instructions may be placed into mass storage devices 506 in the factory, or in the field, though, for example, a distribution medium (not shown), such as a compact disc (CD), or through communication interfaces 510 (from a distribution server (not shown)).

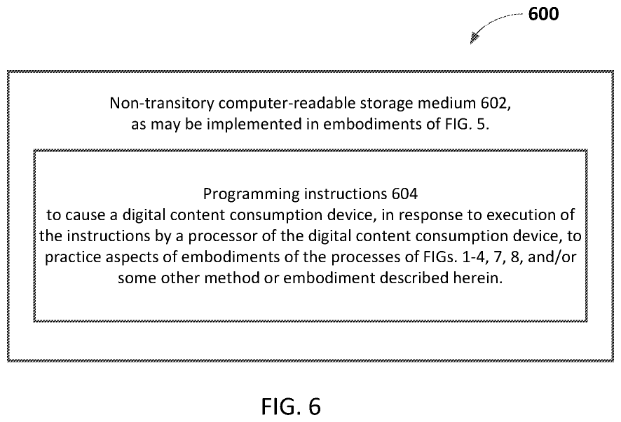

FIG. 6 illustrates an example non-transitory computer-readable storage media 602 having instructions configured to practice all or selected ones of the operations associated with the processes described above. As illustrated, non-transitory computer-readable storage medium 602 may include a number of programming instructions 604. Programming instructions 604 may be configured to enable a device, e.g., computing device 500, in response to execution of the programming instructions, to perform one or more operations of the processes described in reference to FIGS. 1-4, 7, 8, and/or some other method, process, or technique described herein, in whole or in part. In alternate embodiments, programming instructions 604 may be disposed on multiple non-transitory computer-readable storage media 602 instead. In still other embodiments, programming instructions 604 may be encoded in transitory computer-readable signals.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

Example 1 includes a method comprising: receiving, by a device over a compute express link (CXL) link from a host, a protocol packet; receiving, by the device from the host, an integrity indication related to the protocol packet, wherein the integrity indication is different than a medium access control (MAC) epoch indication; and processing, based on the integrity indication, the protocol packet.

Example 2 includes the method of example 1, and/or some other example herein, wherein the integrity indication is received over a CXL-cache/mem protocol interface (CPI).

Example 3 includes the method of any of examples 1-2, and/or some other example herein, wherein the integrity indication is or includes an epoch validity indication.

Example 4 includes the method of example 3, and/or some other example herein, wherein the epoch validity indication is a single-bit indication

Example 5 includes the method of any of examples 1-4, and/or some other example herein, wherein the integrity indication is or includes an epoch identifier (ID).

Example 6 includes the method of example 5, and/or some other example herein, wherein the epoch ID is a single-bit identifier.

Example 7 includes the method of any of examples 1-6, and/or some other example herein, wherein the integrity indication is or includes a port identifier (ID).

Example 8 includes the method of example 7, and/or some other example herein, wherein the port ID is a variable-width field.

Example 9 includes a method to be performed by a link controller of a first electronic device, wherein the method comprises: identifying, from a second electronic device over a communication link, a flit related to a request from the second electronic device to access a resource of the first electronic device, wherein the flit is an element of a message authentication code (MAC) epoch; generating, based on the flit, a cache/mem interface message related to the request, wherein the cache/mem interface message includes an indication of the MAC epoch; and transmitting, to a device fabric of the first electronic device, the cache/mem interface message prior to receipt of a MAC related to the MAC epoch.

Example 10 includes the method of example 9, and/or some other example herein, further comprising: identifying, subsequent to transmission of the cache/mem interface message, the MAC; processing the MAC; and providing, based on the processing of the MAC, an indication related to authentication of the MAC.

Example 11 includes the method of any of examples 9-10, and/or some other example herein, wherein the indication of the MAC epoch includes an indication of validity of an identifier related to the MAC epoch.

Example 12 includes the method of example 11, and/or some other example herein, wherein the identifier is an epoch identifier (ID) that identifies the MAC epoch.

Example 13 includes the method of example 12, and/or some other example herein, wherein the epoch ID is a single bit.

Example 14 includes the method of example 11, and/or some other example herein, wherein the identifier is a port identifier (ID) that is related to a port on which the flit was received.

Example 15 includes the method of any of examples 9-14, and/or some other example herein, wherein the link controller is a compute express link (CXL) controller.

Example 16 includes the method of any of examples 9-15, and/or some other example herein, wherein the cache/mem interface message is a compute express link (CXL) cache/mem protocol interface (CPI) message.

Example 17 includes a method to be performed by a device fabric of a first electronic device, wherein the method comprises: identifying, from a link controller of the first electronic device, a cache/mem interface message related to a flit of a message authentication code (MAC) epoch, wherein the cache/mem interface message includes an indication of a request related to the flit, and wherein the cache/mem interface message includes an indication of the MAC epoch; at least partially processing the request; and identifying, from the link controller after at least partially processing the request, an indication of validity of a MAC related to the MAC epoch.

Example 18 includes the method of example 17, and/or some other example herein, wherein the method further comprises: completing, based on the indication of validity, the processing of the request; and providing, to the link controller, an indication of a result of processing the request.

Example 19 includes the method of any of examples 17-18, and/or some other example herein, wherein the indication of the MAC epoch includes an indication of validity of an identifier related to the MAC epoch.

Example 20 includes the method of example 19, and/or some other example herein, wherein the identifier is an epoch identifier (ID) that identifies the MAC epoch.

Example 21 includes the method of example 20, and/or some other example herein, wherein the epoch ID is a single bit.

Example 22 includes the method of example 19, and/or some other example herein, wherein the identifier is a port identifier (ID) that is related to a port on which the flit was received.

Example 23 includes the method of any of examples 17-22, and/or some other example herein, wherein the link controller is a compute express link (CXL) controller.

Example 24 includes the method of any of examples 17-23, and/or some other example herein, wherein the cache/mem interface message is a compute express link (CXL) cache/mem protocol interface (CPI) message.

Example Z01 may include an apparatus comprising means to perform one or more elements of a method described in or related to any of the examples herein, and/or any other method, process, or technique process described herein, or portions or parts thereof.

Example Z02 may include an apparatus comprising logic, modules, or circuitry to perform one or more elements of a method described in or related to any of the examples herein, and/or any other method, process, or technique described herein, or portions or parts thereof.

Example Z03 may include a method, technique, or process as described in or related to any of the examples herein, and/or any other method, process, or technique described herein, or portions or parts thereof.

Example Z04 may include a signal as described in or related to any of the examples herein, and/or any other method, process, or technique described herein, or portions or parts thereof.

Example Z05 may include an apparatus comprising one or more processors and non-transitory computer-readable media that include instructions which, when executed by the one or more processors, are to cause the apparatus to perform one or more elements of a method described in or related to any of the examples herein, and/or any other method, process, or technique described herein, or portions or parts thereof.

Example Z06 may include one or more non-transitory computer readable media comprising instructions that, upon execution of the instructions by one or more processors of an electronic device, are to cause the electronic device to perform one or more elements of a method described in or related to any of the examples herein, and/or any other method, process, or technique described herein, or portions or parts thereof.

Example Z07 may include a computer program related to one or more elements of a method described in or related to any of the examples herein, and/or any other method, process, or technique described herein, or portions or parts thereof.

1. An electronic device comprising:
an interface to communicatively couple with a second electronic device via a communication link; and
a link controller configured to:
identify, from the second electronic device over the communication link, a flit related to a request from the second electronic device to access a resource of the electronic device, wherein the flit is an element of a message authentication code (MAC) epoch;
generate, based on the flit, a cache/mem interface message related to the request, wherein the cache/mem interface message includes an indication of the MAC epoch; and
transmit, to a device fabric of the electronic device, the cache/mem interface message prior to receipt of a MAC related to the MAC epoch.

2. The electronic device of claim 1, wherein the link controller is further to:
identify, subsequent to transmission of the cache/mem interface message, the MAC;
process the MAC; and
provide, based on the processing of the MAC, an indication related to authentication of the MAC.

3. The electronic device of claim 1, wherein the indication of the MAC epoch includes an indication of validity of an identifier related to the MAC epoch.

4. The electronic device of claim 3, wherein the identifier is an epoch identifier (ID) that identifies the MAC epoch.

5. The electronic device of claim 4, wherein the epoch ID is a single bit.

6. The electronic device of claim 3, wherein the identifier is a port identifier (ID) that is related to a port on which the flit was received.

7. The electronic device of claim 1, wherein the link controller is a compute express link (CXL) controller.

8. The electronic device of claim 1, wherein the cache/mem interface message is a compute express link (CXL) cache/mem protocol interface (CPI) message.

9. An electronic device comprising:
a link controller to couple with a second electronic device via a communication link; and
a device fabric configured to:
identify, from the link controller, a cache/mem interface message related to a flit of a message authentication code (MAC) epoch, wherein the cache/mem interface message includes an indication of a request related to the flit, and wherein the cache/mem interface message includes an indication of the MAC epoch;
at least partially process the request; and
identify, from the link controller after at least partially processing the request, an indication of validity of a MAC related to the MAC epoch.

10. The electronic device of claim 9, wherein the device fabric is further to:
completing, based on the indication of validity, the processing of the request; and
providing, to the link controller, an indication of a result of processing the request.

11. The electronic device of claim 9, wherein the indication of the MAC epoch includes an indication of validity of an identifier related to the MAC epoch.

12. The electronic device of claim 11, wherein the identifier is an epoch identifier (ID) that identifies the MAC epoch.

13. The electronic device of claim 12, wherein the epoch ID is a single bit.

14. The electronic device of claim 11, wherein the identifier is a port identifier (ID) that is related to a port on which the flit was received.

15. The electronic device of claim 9, wherein the link controller is a compute express link (CXL) controller.

16. The electronic device of claim 9, wherein the cache/mem interface message is a compute express link (CXL) cache/mem protocol interface (CPI) message.

17. An electronic device comprising:
an interface to communicatively couple with a second electronic device via a compute express link (CXL);
a device fabric; and
a CXL controller configured to:
identify, from the second electronic device over the CXL link, a flit related to a request from the second electronic device to access a resource of the electronic device, wherein the flit is an element of a message authentication code (MAC) epoch;
generate, based on the flit, a CXL-cache/mem protocol interface (CPI) message related to the request, wherein the CPI message includes an indication of the MAC epoch; and
transmit, to the device fabric, the CPI message prior to receipt of a MAC related to the MAC epoch.

18. The electronic device of claim 17, wherein the device fabric is configured to:
identify, from the link controller, the CPI message related to a flit of a message authentication code (MAC) epoch, wherein the cache/mem interface message includes an indication of a request related to the flit, and wherein the cache/mem interface message includes an indication of the MAC epoch;
at least partially process, based on the CPI message, the request; and
identify, from the link controller after at least partially processing the request, an indication of validity of a MAC related to the MAC epoch.

19. The electronic device of claim 17, wherein the electronic device is a CXL host device.

20. The electronic device of claim 17, wherein the second electronic device is a CXL host device.
